(19) United States
(12) Patent Application Publication
(10) Pub. No.: US 2021/0156765 A1
(43) Pub. Date: May 27, 2021

(54) RIM REPLACING MECHANISM PROVIDED TO TIRE TESTER AND RIM REPLACING METHOD

(71) Applicant: KABUSHIKI KAISHA KOBE SEIKO SHO (KOBE STEEL, LTD.), Hyogo (JP)

(72) Inventors: Takashi SUMITANI, Takasago-shi, Hyogo (JP); Yu SUMIMOTO, Takasago-shi, Hyogo (JP)

(73) Assignee: KABUSHIKI KAISHA KOBE SEIKO SHO (KOBE STEEL, LTD.), Hyogo (JP)

(21) Appl. No.: 16/981,952

(22) PCT Filed: Mar. 15, 2019
(86) PCT No.: PCT/JP2019/010846

§ 371 Date: Sep. 17, 2020

(30) Foreign Application Priority Data
Mar. 28, 2018 (JP) 2018-062134
Mar. 7, 2019 (JP) 2019-041876

(51) Int. Cl. G01M 17/02; B60C 19/00

(52) U.S. Cl. CPC G01M 17/021; B60C 19/00

(57) ABSTRACT

A rim replacing mechanism includes a pressing member including a spring and a body having a pressing surface applying downward pressing force to an upper surface of an upper rim, and an actuator configured to vertically displace the body within a range including an upper position and a lower position. As to the lower position, the body is configured to shift downward toward the lower position while the pressing surface of the body is applying the downward pressing force to the upper surface of the upper rim, to dispose the upper surface of the upper rim to be separated downward from a lower surface of an upper spindle. The spring is configured to apply downward pressing force to the body disposed at the lower position.

### TECHNICAL FIELD

The present invention relates to a rim replacing mechanism included in a tire testing machine, and to a rim replacing method.

### BACKGROUND ART

There has conventionally been known a tire testing machine configured to test a plurality of tires having varied inner circumferential diameters or varied tread surface widths. Such a tire testing machine includes a plurality of rims adapted to a plurality of tire sizes. The tire testing machine also includes a spindle to which one of the plurality of rims adapted to a size of a tire to be tested is attached. The tire testing machine accordingly includes a rim replacing mechanism configured to attach and detach a rim to and from the spindle.

For example, Patent Literature 1 discloses a tire test device including an upper rim and a lower rim configured to hold a tire, an upper spindle and a lower spindle configured to hold the upper and lower rims having axes kept coaxially, an upper spindle housing supporting the upper spindle to be rotatable about an axis thereof, and an upper frame holding the upper spindle housing. The tire test device according to Patent Literature 1 includes a rim replacing mechanism configured to replace the upper rim fixed to the upper spindle by means of a permanent magnet. In the tire test device, the upper spindle is provided with a plurality of permanent magnets magnetically attracting the upper rim and disposed around the axis of the upper spindle, and the upper frame is provided with a separator configured to press a surface of the upper rim spaced apart radially outward from the upper spindle to separate the upper rim magnetically attracted to the permanent magnets from the upper spindle. This separator is fixed to the upper frame so as not to be rotatable integrally with the upper spindle.

As disclosed in Patent Literature 1, the rim replacing mechanism in the conventional tire testing machine further includes the lower spindle provided with a magnet, and a rim table provided thereon with a replacement rim. In the rim replacing mechanism disclosed in Patent Literature 1, the rim attached to the spindle is detached in accordance with the following procedure.

The separator initially presses the upper rim downward to detach the upper rim from the upper spindle, and the upper rim is disposed on the lower rim. The lower spindle then descends in a state where the upper and lower rims are disposed together (a state where the upper rim is disposed on the lower rim). When the lower rim comes into contact with the rim table in the state where the upper and lower rims are disposed together, the upper and lower rims are transferred from the lower spindle onto the rim table. The lower spindle further descends and stops at a lower limit position below the rim table.

In the rim replacing mechanism, the upper and lower rims are attached respectively to the spindles in accordance with the following procedure (mounting procedure). The lower spindle initially ascends from the lower limit position, and the upper and lower rims mounted on the rim table are transferred onto the lower spindle.

The lower spindle then further ascends. When the upper and lower rims approach the upper spindle, the upper rim out of the upper and lower rims is attracted to the upper spindle with magnetic force of the magnets provided at the upper spindle.

Replacement of the rim, particularly mounting of the upper rim to the upper spindle causes the following problems.

While the upper and lower rims disposed together ascend toward the upper spindle and the upper rim is mounted to the upper spindle, the upper rim is rapidly attracted to the upper spindle with the magnetic force (attracting force) of the magnets. Accordingly, the upper rim rapidly comes into contact with the upper spindle. This contact causes quite large impact force, which is likely to damage contact surfaces (close contact surfaces) of the upper rim and the upper spindle. The contact (magnetic attraction) of the upper rim to the upper spindle also generates large impact noise, which may deteriorate work environment.

### CITATION LIST

### Patent Literature

Patent Literature 1: JP 2010-127848 A (FIG. 2, etc.)

### Summary of Invention

It is an object of the present invention to provide a rim replacing mechanism included in a tire testing machine and a rim replacing method, which achieve mitigation of impact caused when an upper rim to be mounted to an upper spindle comes into contact with the upper spindle.

Provided is a rim replacing mechanism included in a tire testing machine that includes an upper rim and a lower rim configured to hold a tire, an upper spindle detachably provided with the upper rim, having a lower surface in contact with an upper surface of the upper rim mounted to the upper spindle, and having a permanent magnet fixing to the upper spindle with magnetic force, the upper rim mounted to the upper spindle, and a lower spindle provided with the lower rim, and the rim replacing mechanism is configured to replace the upper rim fixed to the upper spindle. The rim replacing mechanism includes: a pressing member including a body and a spring, the body having a pressing surface applying downward pressing force to the upper surface of the upper rim; and an actuator configured to vertically displace the body within a range including an upper position and a lower position. The pressing surface of the body disposed at the upper position is located above the upper surface of the upper rim mounted to the upper spindle. The lower position is located below the upper position. As to the lower position, the body is configured to shift downward toward the lower position while the pressing surface of the body is applying the downward pressing force to the upper surface of the upper rim, to dispose the upper surface of the upper rim to be separated downward from the lower surface of the upper spindle. The spring is configured to apply downward pressing force to the body disposed at the lower position.

### BRIEF DESCRIPTION OF DRAWINGS

FIG. 1 is a plan view (from above) schematically depicting a tire testing machine including a rim replacing mechanism according to an embodiment of the present invention.

FIG. 2 is a front view schematically depicting the tire testing machine including the rim replacing mechanism according to the present embodiment.

FIG. 3 is a side view schematically depicting the tire testing machine including the rim replacing mechanism according to the present embodiment.

FIG. 4 is a plan view schematically depicting principal constituent elements of the tire testing machine including the rim replacing mechanism according to the present embodiment.

FIG. 5 is a front view of the rim replacing mechanism according to the present embodiment, depicting a state where an upper rim is mounted to an upper spindle.

FIG. 6 is a front view of the rim replacing mechanism according to the present embodiment, depicting a state where a tire test is conducted.

FIG. 7 is a front view of the rim replacing mechanism according to the present embodiment, depicting a state where the upper rim is detached from the upper spindle (upon upper rim separation).

### DESCRIPTION OF EMBODIMENTS

An embodiment of the present invention is described hereinafter with reference to the drawings. The embodiment to be described below specifically exemplifies the present invention that should not be limited to such specific exemplification.

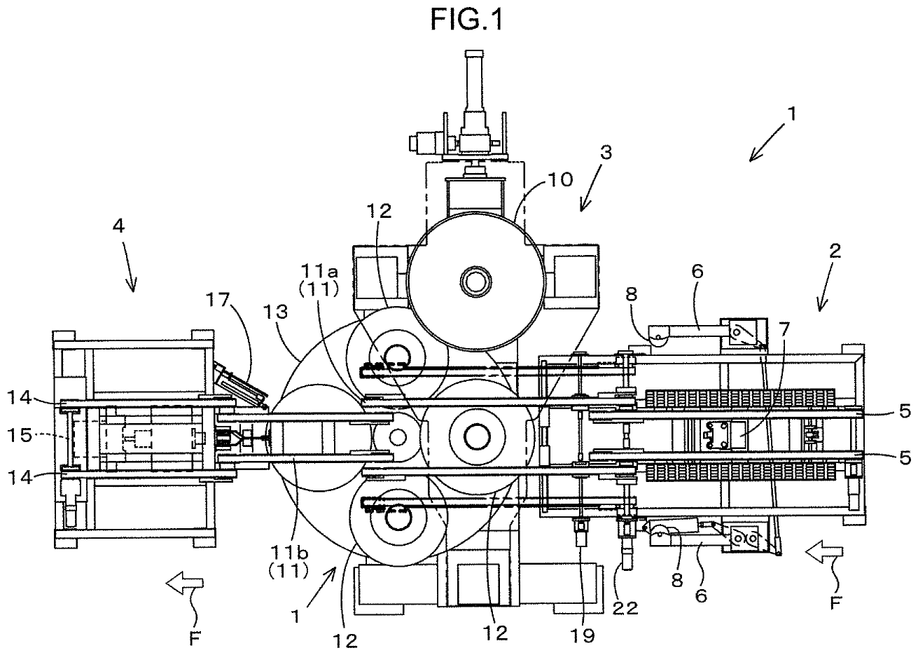

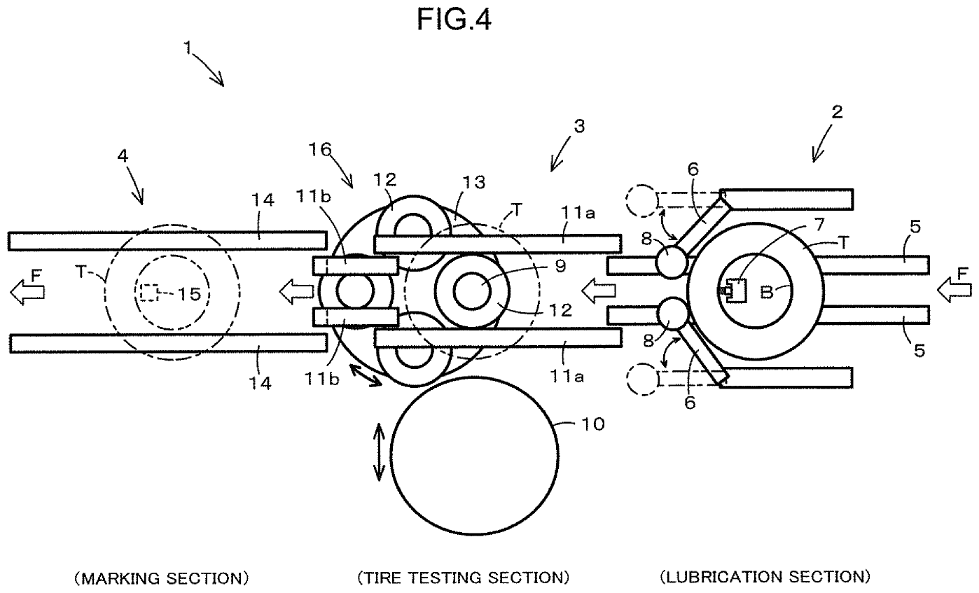

FIG. 1 to FIG. 4 each depict a tire testing machine 1 including a rim replacing mechanism according to the embodiment. The tire testing machine 1 to be described hereinafter has an entire length corresponding to a length of a conveyance route F of a tire Tin a conveyance direction of the tire T. The tire testing machine 1 has a depth direction corresponding to a horizontal direction crossing the conveyance route F, more precisely, the horizontal direction substantially perpendicular to the conveyance route F. The depth direction will also be called a transverse direction or a width direction of the tire testing machine 1.

The tire testing machine 1 includes a lubrication section 2, a tire testing section 3, and a marking section 4. The lubrication section 2 rotates the tire T and simultaneously applies lubrication liquid to a bead portion B of the tire T. The tire testing section 3 causes a spindle unit 9 to rotate the tire T provided with the lubrication liquid by the lubrication section 2, and simultaneously conducts a tire test to detect any singular point on the tire T. The marking section 4 marks a circumferential position of the singular point on the tire T.

The lubrication section 2, the tire testing section 3, and the marking section 4 are aligned in the mentioned order from an upstream side to a downstream side on the conveyance route F.

The lubrication section 2 is configured to apply the lubrication liquid to the bead portion B of the tire T having been delivered. The lubrication section 2 includes a pair of left and right first conveyors 5 configured to convey the tire T laid horizontally, a pair of left and right arms 6 configured to hold the tire T delivered by the pair of first conveyors 5, and an applicator 7 configured to apply lubrication liquid to the bead portion B (inner circumferential edge) of the tire T held between the pair of arms 6,

Each of the paired first conveyors 5 according to this embodiment is constituted as a belt conveyor including a conveyance belt which is a loop-shaped strip forming an endless track, but the first conveyors 5 should not be limited to such belt conveyors.

The paired arms 6 each have a tip provided with a rotatable roller 8. The pair of arms 6 in the lubrication section 2 sandwiches the delivered tire T from both left and right outer sides, and causes the rollers 8 to come into contact with a tread surface constituting an outer circumferential surface of the tire T. The rollers 8 rotate to allow the tire T to rotate about a vertical axis. The applicator 7 is configured to be vertically shiftable. The applicator 7 has a brush shape and is configured to ascend to come into contact with the bead portion B of the tire T held between the pair of arms 6 and apply the lubrication liquid to the bead portion B. After the application, the applicator 7 is returned to a position below the first conveyors 5 to be restored.

The pair of first conveyors 5 conveys the tire T thus provided with the lubrication liquid from the lubrication section 2 to the tire testing section 3.

The tire testing section 3 includes the spindle unit 9, a drum 10, a pair of left and right second conveyors 11, and a rim table 13.

The spindle unit 9 holds the tire T rotatably about the vertical axis. The drum 10 has a cylindrical outer circumferential surface having a vertically directed center axis, and is disposed laterally to the spindle unit 9 so as to be rotatable about the center axis.

The pair of second conveyors 11 conveys the tire T delivered from the lubrication section 2 while the tire T is kept laid horizontally. The rim table 13 has a horizontal rim mounting surface allowing a plurality of rims 12 to be mounted thereon.

The paired second conveyors 11 according to this embodiment are each constituted by an upstream conveyor 11a and a downstream conveyor 11b disposed downstream of the upstream conveyor 11a in the conveyance direction. The upstream and downstream conveyors 11a and 11b are each constituted as a belt conveyor including a conveyance belt which is a loop-shaped strip forming an endless track.

The tire testing section 3 further includes a rotary drive section (not depicted) configured to rotationally drive the spindle unit 9.

The spindle unit 9 includes an upper spindle 9a and a lower spindle 9b. The upper spindle 9a and the lower spindle 9b are bar members rotatable about a common vertical axis.

The rims 12 are each constituted by an upper rim 12a attached to a lower end of the upper spindle 9a, and a lower rim 12b attached to an upper end of the lower spindle 9b. The upper rim 12a and the lower rim 12b are disposed to vertically sandwich the tire T disposed on the pair of second conveyors 11. The rims 12 are each halved into the upper rim 12a and the lower rim 12b.

The spindle unit 9 will be detailed later in terms of its configuration.

The drum 10 is disposed adjacent to the spindle unit 9 such that the outer circumferential surface of the drum 10 can be radially close to and separate from the tread surface of the tire T held by the spindle unit 9. The tire T is tested while rotating at predetermined rotational speed in a state where the outer circumferential surface of the drum 10 is in contact with the tread surface of the tire T held by the spindle unit 9. The drum 10 has a rotary shaft provided with a load cell (not depicted) configured to measure force, a moment, or the like applied from the rotating tire T to the drum 10.

Tire uniformity or the like is calculated from a result of measurement by the load cell. Measured as a “singular point” is a circumferential position, an axial position, or the like where the tire T has the largest repulsive force. The tire testing section 3 conducts the tire test including measurement of the tire uniformity as well as measurement of an outer shape and the like. The tire T having the “singular point” thus measured is rotated by the tire testing section 3 by a predetermined angle, and is then sent from the tire testing section 3 to the marking section 4.

The marking section 4 includes a pair of left and right third conveyors 14, and an mark stamping device 15. The pair of third conveyors 14 shifts, in the conveyance direction, the tire T kept laid horizontally. The mark stamping device 15 marks a predetermined position of the tire T (e.g. a predetermined position on the inner circumference of the tire T) positioned on the pair of third conveyors 14. The paired third conveyors 14 according to this embodiment are each constituted as a belt conveyor including a conveyance belt which is a loop-shaped strip forming an endless track.

In a case where the tire testing section 3 conducts the tire test relevant to tire uniformity of the tire T, the mark stamping device 15 provides the circumferential position on the tire T having a “singular point” in terms of the tire uniformity with a mark like a uniformity mark indicating the singular point specified in the tire test. In another case where the tire test being conducted is relevant to measurement of the outer shape or the like, the tire T may be provided with a mark other than the uniformity mark.

The tire testing section 3 further includes a slide mechanism 22. The slide mechanism 22 is constituted as a gap change mechanism configured to change a transverse gap between the pair of upstream conveyors 11a in the pair of second conveyors 11 by shifting the pair of upstream conveyors 11a to be transversely close to and separate from each other. The slide mechanism 22 is configured to slide the pair of upstream conveyors 11a to be close to and separate from each other.

The pair of upstream conveyors 11a slides to be close to and separate from each other so as to allow, when the tire T to be tested is changed in size, the rim 12 adapted to the changed size to be extracted from the rim table 13 positioned below the second conveyors 11. The tire testing machine 1 is configured to change the gap between the pair of upstream conveyors 11a in accordance with an outer circumferential diameter of the rim.

The rim table 13 is a disc plate member disposed above the upper end of the lower spindle 9b withdrawn downward. The tire testing section 3 further includes a rotary drive mechanism 18. The rotary drive mechanism 18 supports the rim table 13 rotatably about a vertical axis, and is configured to rotate the rim table 13. The rim table 13 according to the present embodiment is constituted as a rotary table.

The rim mounting surface of the rim table 13 receives the plurality of rims 12 different in size from one another. The plurality of rims 12 can be mounted at a plurality of positions aligned in a rotary circumferential direction of the rim table 13. The upper rim 12a and the lower rim 12b constituting each of the rims 12 mounted on the rim table 13 are vertically stacked and mounted on the rim mounting surface, and can be attached to the upper spindle 9a and the lower spindle 9b, respectively.

The rim table 13 according to the present embodiment can be provided with four rims 12 different in size from one another, at four positions aligned in the rotary circumferential direction on the rim mounting surface. The rim table 13 is disposed to have a rotary center axis positioned closer to an export port (outlet) than the spindle unit 9 in the conveyance direction.

The tire testing section 3 has a rim automatically changing function. the rim automatically changing function enables, even if the tire testing section 3 receives tires T varied in size to have inner circumferential diameters or tread surface widths different from each other, automatic replacement to the rim 12 sized to be adapted to the size of each of the delivered tires T for continuous tire tests of the tires T with no holdup.

Specifically, the rim automatically changing function achieves automatic change, according to information on size or the like of the forthcoming tire T delivered from the upstream lubrication section 2, from the rim 12 attached to the spindle unit 9 to the rim 12 adapted to the size or the like of the tire T, for conduction of the tire tests of the tires T varied in size.

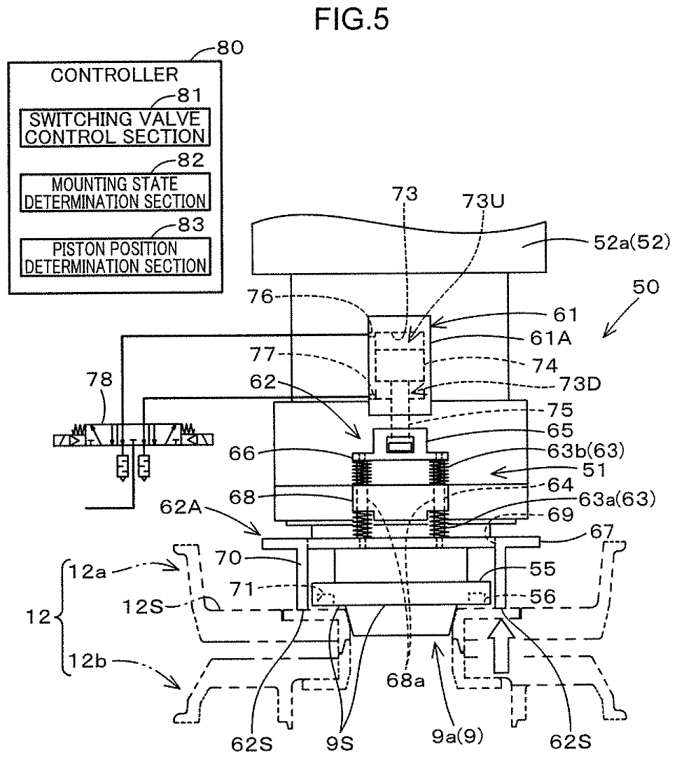

As depicted in FIG. 5 to FIG. 7, the present embodiment provides a rim replacing mechanism 50 (precisely a rim separating mechanism 51) inventively configured to replace the upper rim 12a at the spindle unit 9, specifically, the upper spindle 9a. Details thereof will be described below.

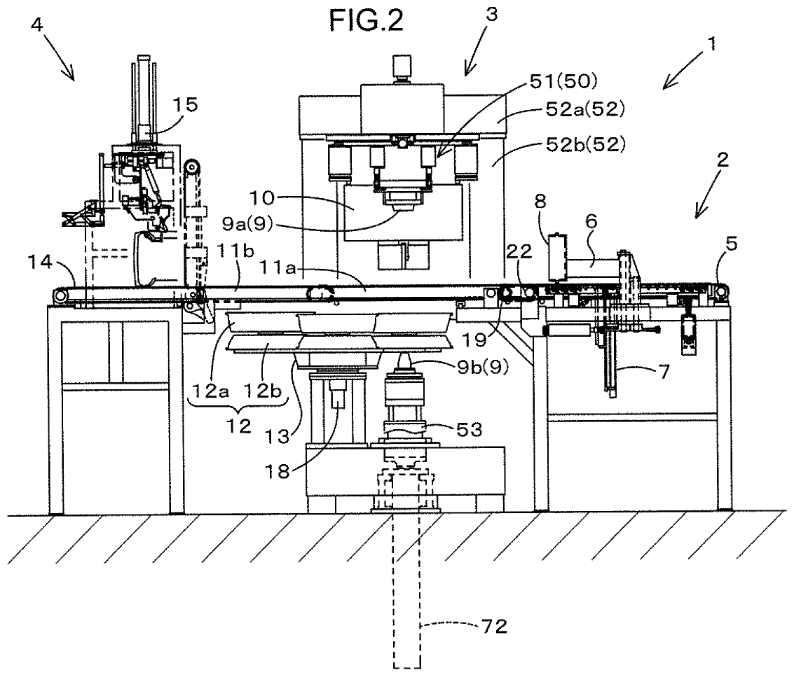

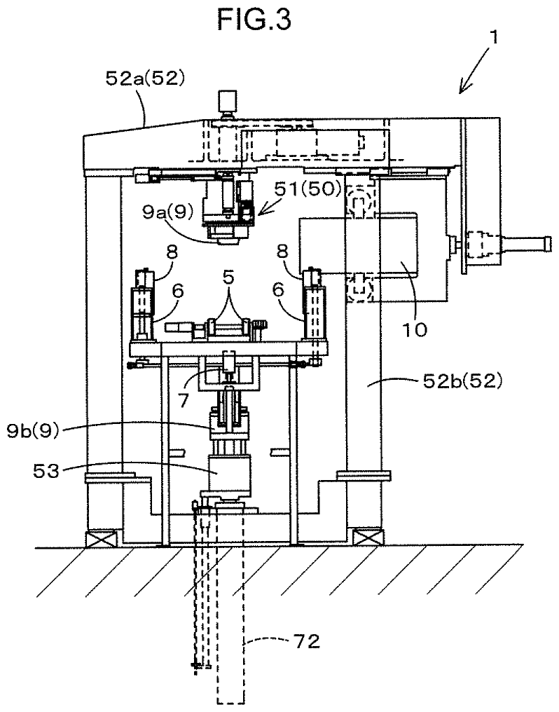

As depicted in FIG. 2 and FIG. 3, the tire testing machine 1 according to the present embodiment includes a frame 52 and a housing 53. The frame 52 is partially disposed above the upstream conveyors 11a configured to convey the tire T to be tested, which is kept laid horizontally. The frame 52 partially disposed above the upstream conveyors 11a extends over the upstream conveyors 11a.

The frame 52 includes an upper frame 52a rotatably supporting the upper spindle 9a, and a lower frame 52b supporting the upper frame 52a. The upper spindle 9a is provided therebelow with the lower spindle 9b. The housing 53 is provided at the lower frame 52b and rotatably supports the lower spindle 9b.

The upper spindle 9a has an engagement part. The engagement part is provided at a lower end surface of the upper spindle 9a and has a recess that is recessed upward from the lower end surface. The upper end of the lower spindle 9b is fitted to the engagement part to couple the upper and lower spindles 9a and 9b connected like a single bar.

As depicted in FIG. 5, the upper spindle 9a includes a spindle body and a flange 55. The spindle body has a columnar shape vertically extending and surrounding a rotary center axis of the upper spindle 9a, and the flange 55 annularly expands radially outward from an outer circumferential surface of the spindle body. The flange 55 is provided at a lower end of the spindle body. The flange 55 is shaped to project radially outward from the outer circumferential surface at the lower end of the spindle body. The upper spindle 9a has a portion located below the flange 55 and provided with the engagement part.

The upper spindle 9a has a lower surface 9S, and the upper rim 12a has an upper surface 12S. The upper surface 12S of the upper rim 12a is in contact with the lower surface 9S of the upper spindle 9a in a state where the upper rim 12a is mounted to the upper spindle 9a. In other words, the lower surface 98 of the upper spindle 9a vertically faces the upper surface 12S of the upper rim 12a.

The lower surface 9S of the upper spindle 9a is constituted by a lower surface of the flange 55 in the present embodiment. Specifically, the lower surface 9S is constituted by an annular surface around the rotary center axis of the upper spindle 9a in a bottom view. The annular surface is constituted by a region between two concentric circles different in diameter around the rotary center axis in the bottom view. In the present embodiment, the lower surface 9S of the flange 55 in the upper spindle 9a is flat, more specifically, flat and perpendicular to the rotary center axis of the upper spindle 9a. The lower surface 98 is, however, not limitedly flat, but may alternatively include a curved surface. The lower surface 9S may still alternatively be provided on a portion other than the flange 55 in the upper spindle 9a. The lower surface 9S of the upper spindle 9a may not be positioned at the lowest level among surfaces of the upper spindle 9a. The lower surface 9S of the upper spindle 9a has only to be directed downward and vertically face the upper surface 12S of the upper rim 12a.

The upper surface 12S of the upper rim 12a is constituted by an annular surface around a rotary center axis of the upper rim 12a in a planar view. The annular surface is constituted by a region between two concentric circles different in diameter around the rotary center axis of the upper rim 12a in the planar view. In the present embodiment, the upper surface 12S of the upper rim 12a is flat, more specifically, flat and perpendicular to the rotary center axis of the upper rim 12a. The upper surface 128 is, however, not limitedly flat, but may alternatively include a curved surface. The upper surface 128 of the upper rim 12a may not be positioned at the highest level among surfaces of the upper rim 12a. The upper surface 12S of the upper rim 12a has only to be directed upward and vertically face the lower surface 9S of the upper spindle 9a.

The upper surface 12S of the upper rim 12a vertically faces a pressing surface 62S of a pressing member 62 to be described later, and receives downward pressing force from the pressing surface 62S. The upper surface 12S is in contact with the lower surface 9S of the upper spindle 9a when the upper rim 12a is mounted to the upper spindle 9a. The upper surface 12S of the upper rim 12a according to the present embodiment includes a first portion in contact with the pressing surface 62S and a second portion in contact with the lower surface 9S flush with the first portion. The first and second portions may alternatively be different in level.

The flange 55 includes at least one mounting part 71. The flange 55 according to the present embodiment includes a plurality of mounting parts 71. The mounting parts 71 are each constituted by a recess that is recessed upward from the lower surface 9S of the flange 55. The plurality of mounting parts 71 is aligned to be circumferentially spaced apart from each other in the lower surface 9S.

The upper spindle 9a has a plurality of permanent magnets 56. The plurality of permanent magnets 56 is disposed to be circumferentially spaced apart from each other around the rotary center axis of the upper spindle 9a. The plurality of permanent magnets 56 is configured to fix (magnetically attract) the upper rim 12a to the upper spindle 9a with magnetic force thereof. The upper rim 12a is made of a material attracted to the permanent magnets 56.

The plurality of permanent magnets 56 is accommodated in the plurality of mounting parts 71 provided in the lower surface 9S of the flange 55 in the upper spindle 9a. These permanent magnets 56 are accommodated in the plurality of mounting parts 71 each opened downward and having a top surface. The plurality of permanent magnets 56 generates larger magnetic force in a region below the lower surface 9S of the flange 55 in the upper spindle 9a. Accordingly, the upper rim 12a is magnetically attracted to the upper spindle 9a, specifically, to the lower surface 9S of the flange 55 in the upper spindle 9a.

The lower spindle 9b is rotatably attached to the housing 53. The tire testing machine 1 further includes a lift cylinder 72. The lift cylinder 72 extends downward from the housing 53. The lift cylinder 72 is configured to shift vertically upward and downward the lower spindle 9b.

The upper end of the lower spindle 9b is tapered to be gradually narrowed upward. The upper end of the lower spindle 9b is engageable with the engagement part of the upper spindle 9a. The lower spindle 9b has a flange provided below the tapered portion, similarly to the upper spindle 9a. The flange has an upper surface provided with a plurality of permanent magnets (not depicted).

When the upper and lower rims 12a and 12b are mounted, the lower rim 12b is fixed to the lower spindle 9b with magnetic force of the permanent magnets at the lower spindle 9b in the rim replacing mechanism 50. The upper rim 12a is disposed on the lower rim 12b such that the upper and lower rims 12a and 12b are stacked. The lower spindle 9b is then drawn upward (the lower spindle 9b is displaced upward) by the lift cylinder 72, and the upper rim 12a is fixed to the upper spindle 9a with magnetic force of the permanent magnets 56 positioned above at the flange 55 of the upper spindle 9a.

When the lower rim 12b is detached from the lower spindle 9b, the lower spindle 9b is displaced downward by the lift cylinder 72 so that the lower rim 12b is mounted on an upper surface of the rim table 13. The rim table 13 restricts a downward shift of the lower rim 12b mounted thereon. When the lower spindle 9b shifts further downward, the lower rim 12b is thus detached from the lower spindle 9b and is disposed on the rim table 13.

In the tire testing machine 1, the upper spindle 9a is fixed to the frame 52 so as not to be shifted vertically. Accordingly, the upper rim 12a is detached from the upper spindle 9a in a mariner (separating manner) different from the manner of separating the lower rim 12b.

Specifically, the rim replacing mechanism 50 according to the present embodiment includes the rim separating mechanism 51 configured to forcibly separate, from the upper spindle 9a, the upper rim 12a fixed to the upper spindle 9a by the permanent magnets 56. The rim separating mechanism 51 is configured to press downward a portion, in the upper surface 12S of the upper rim 12a, spaced apart radially outward from the upper spindle 9a. The rim separating mechanism 51 will be described specifically below.

As depicted in FIG. 5 to FIG. 7, the rim separating mechanism 51 in the rim replacing mechanism 50 is configured to press downward the upper surface 12S of the upper rim 12a with force more than a value obtained by subtracting weight of the upper rim 12a from magnetic force, of the plurality of permanent magnets 56 at the upper spindle 9a, attracting the upper rim 12a to the upper spindle 9a.

The rim replacing mechanism 50 (the rim separating mechanism 51) includes at least one pressing member 62, and at least one air cylinder 61 (actuator). Specifically, the rim replacing mechanism 50 according to the present embodiment includes a single pressing member 62 and a plurality of air cylinders 61. FIG. 5 to FIG. 7 each depict only one pressing member 62 and one air cylinder 61. The plurality of air cylinders 61 is disposed to be circumferentially spaced apart from each other around the upper spindle 9a. The pressing member 62 is disposed below the plurality of air cylinders 61.

The pressing member 62 includes a body 62A and an elastic part 63. The body 62A has at least one pressing surface 62S applying downward pressing force to the upper surface 12S of the upper rim 12a. The elastic part 63 is provided to apply elastic force as vertical force to the body 62A.

The elastic part 63 includes at least one first spring 63a and at least one second spring 63b. The first spring 63a is disposed below an intermediate member 68 to be described later, and is provided to apply mainly downward pressing force (elastic force) to the body 62A. The second spring 63b is disposed above the intermediate member 68, and is provided to apply mainly upward pressing force (elastic force) to the body 62A to support the body 62A.

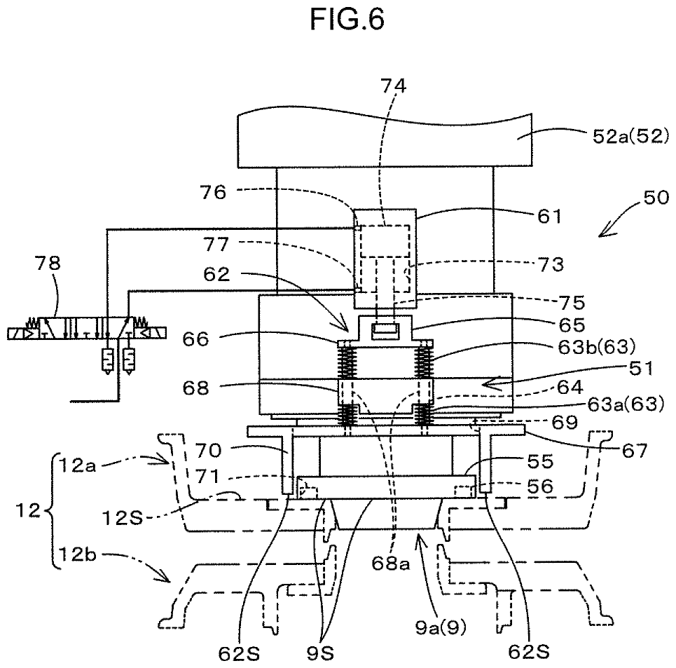

The air cylinders 61 are configured to vertically displace the body 62A of the pressing member 62 within a range including an upper position and a lower position. As depicted in FIG. 6, the body 62A disposed at the upper position has the pressing surface 62S positioned above the upper surface 12S of the upper rim 12a mounted to the upper spindle 9a. The lower position is located below the upper position. As to the lower position, the body 62A is configured to shift downward toward the lower position while the pressing surface 62S of the body 62A is applying the downward pressing force to the upper surface 12S of the upper rim 12a, to dispose the upper surface 12S of the upper rim 12a to be separated downward from the lower surface 9S of the upper spindle 9a as depicted in FIG. 5. According to the present embodiment, the upper position is a position such that the pressing surface 62S is located above the lower surface 9S of the upper spindle 9a, whereas the lower position is a position such that the pressing surface 62S is located below the lower surface 9S of the upper spindle 9a.

The body 62A is configured to be vertically displaceable between a body lower limit position and a body upper limit position. The body 62A disposed at the body lower limit position is located at a lowermost position in the vertically displaceable range, and the body 62A is positioned correspondingly to a substantial lower stroke end of the air cylinder 61. The body 62A disposed at the body upper limit position is located at an uppermost position in the vertically displaceable range, and the body 62A is positioned correspondingly to a substantial upper stroke end of the air cylinder 61.

The lower position of the body 62A may not necessarily match the body lower limit position and may be located above the body lower limit position. The upper position of the body 62A may not necessarily match the body upper limit position and may be located below the body upper limit position. The air cylinder 61 functioning as the actuator operates to displace the body 62A between the body lower limit position and the body upper limit position.

FIG. 5 depicts a state where the body 62A is disposed at a standby position. When the body 62A is disposed at the standby position, the elastic force of the elastic part 63 is balanced with weight of the body 62A. The pressing surface 62S of the body 62A disposed at the standby position is located below the lower surface 9S of the upper spindle 9a. The standby position may match the lower position, may be located between the lower position and the body lower limit position, or may match the body lower limit position.

When the body 62A is disposed at the lower position, the first spring 63a applies its elastic force as downward pressing force to the body 62A. In a case where the standby position is located below the lower position and the body 62A is disposed at the standby position, the first spring 63a is preferably configured to apply downward pressing force to the body 62A, but may not necessarily be configured to apply the downward pressing force to the body 62A. The first spring 63a may be expanded maximumly when the body 62A is disposed below the lower position.

Each of the air cylinders 61 includes a cylinder body 61A, a piston 74, and a cylinder rod 75. The cylinder body 61A is a member having a tubular shape (specifically, a cylindrical shape) partitioning a cylinder chamber 73. The piston 74 is accommodated in the cylinder chamber 73 and divides the cylinder chamber 73 into an upper chamber 73U and a lower chamber 73D. The piston 74 is configured to vertically ascend and descend in the cylinder chamber 73. The body 62A of the pressing member 62 is configured to be vertically displaced along with a vertical shift of the piston 74. The cylinder body 61A in each of the air cylinders 61 is attached to the frame 52 by means of a bracket.

The air cylinders 61 are configured to generate downward pressing force. The number of provided air cylinders 61 is set appropriately in accordance with the number or strength of magnetic force of provided permanent magnets 56. The rim replacing mechanism 50 according to the embodiment depicted in FIG. 5 to FIG. 7 includes two air cylinders 61. The plurality of air cylinders 61 is preferred to be disposed to be circumferentially spaced apart from each other. All the air cylinders 61 are configured to operate in synchronization with each other.

The cylinder chamber 73 of each of the air cylinders 61 is supplied with compressed air generated by a compressor (not depicted).

The cylinder rod 75 is coupled to a lower end of the piston 74 and is configured to be vertically shiftable along with a vertical shift of the piston 74. The cylinder rod 75 according to the present embodiment is constituted by a bar member extending downward from the piston 74. The cylinder rod 75 has a lower end coupled to the body 62A of the pressing member 62.

As depicted in FIG. 5, the rim replacing mechanism 50 further includes a switching valve 78, a controller 80, and a plurality of sensors.

The cylinder body 61A of the air cylinder 61 includes an upper port 76 communicating with the upper chamber 73U and a lower port 77 communicating with the lower chamber 73D in the cylinder chamber 73. The upper port 76 and the lower port 77 can each be supplied with compressed air from the compressor (not depicted). The compressor and the two ports 76 and 77 are connected via two pipes. The switching valve 78 is interposed between the compressor and the air cylinder 61 and is configured to switch between states of supplying compressed air to the two ports 76 and 77.

The switching valve 78 is constituted by an electromagnetic switching valve or the like. The switching valve 78 is configured to selectively switch between flow paths. The switching valve 78 is configured to switch among states of supplying compressed air, including a “state of supplying compressed air to the upper port 76 and opening the lower port 77”, a “state of supplying compressed air to the lower port 77 and opening the upper port 76”, and a “state of opening both the upper and lower ports 76 and 77”.

The plurality of sensors includes a first sensor (not depicted) configured to detect whether or not the upper rim 12a is mounted to the upper spindle 9a, and a second sensor (not depicted) configured to detect a position of the piston 74 in the air cylinder 61. These sensors output signals received by the controller 80.

The controller 80 is constituted by a computer or the like. The controller 80 includes, as functional sections, a switching valve control section 81, a mounting state determination section 82, and a piston position determination section 83.

The switching valve control section 81 controls operation of the switching valve 78. The mounting state determination section 83 determines whether or not the upper rim 12a is mounted to the upper spindle 9a in accordance with the signal transmitted from the first sensor. The piston position determination section 83 determines whether or not the piston 74 in the air cylinder 61 has reached an upper limit position in accordance with the signal transmitted from the second sensor.

The switching valve 78 is constituted as an electromagnetic switching valve configured to switch among a first allowance state, a second allowance state, and an inhibition state in accordance with a command signal transmitted from the controller 80.

The first allowance state allows compressed air from the compressor to be supplied into the lower chamber 73D of the air cylinder 61, and allows air to be exhausted from the upper chamber 73U. The second allowance state allows compressed air from the compressor to be supplied into the upper chamber 73U, and allows air to be exhausted from the lower chamber 73D. The inhibition state allows air to exhausted from the upper chamber 73U and the lower chamber 73D and inhibits supply of the compressed air from the compressor into the upper chamber 73U and the lower chamber 73D.

The pressing member 62 is provided below the air cylinder 61. The elastic part 63 of the pressing member 62 according to the present embodiment includes a plurality of first springs 63a and a plurality of second springs 63b. The plurality of first springs 63a and the plurality of second springs 63b are each constituted as a compression spring (coil spring) but are not limited thereto. Each of the springs may alternatively be constituted as a different type of spring.

The body 62A of the pressing member 62 includes at least one connector member 65 (exemplifying an upper member), at least one bar 64, and at least one lower structure. The body 62A according to the present embodiment includes a plurality of connector members 65, a plurality of bars 64, and one lower structure (exemplifying a lower member) having at least one ring 67 and at least one pressing piece 70. Specifically, the lower structure according to the present embodiment includes a single ring 67 and a plurality of pressing pieces 70. When the body 62A is disposed at the lower position, the first springs 63a according to the present embodiment are configured to apply downward pressing force to the lower structure in the body 62A. More specifically, the first springs 63a are configured to apply downward pressing force to the ring 67 in the lower structure.

The plurality of connector members 65 is positioned correspondingly to the plurality of air cylinders 61. Each of the connector members 65 is coupled to the lower end of the cylinder rod 75 of a corresponding one of the air cylinders 61. Specifically, the lower end of the cylinder rod 75 is coupled to the corresponding connector member 65 so as to be relatively shiftable with vertical play.

At least one of the bars 64 is interposed between each of the connector members 65 and the lower structure. Each of the bars 64 has a bar shape extending downward from the corresponding connector member 65. Each of the bars 64 extends vertically and is disposed between the corresponding connector member 65 and the ring 67 in the lower structure to couple the connector member 65 and the ring 67. Each of the bars 64 penetrates a corresponding one of the first springs 63a and a corresponding one of the second springs 63b to support the corresponding first spring 63a and the corresponding second spring 63b. Specifically, each of the bars 64 is disposed to vertically penetrate centers of the first spring 63a and the second spring 63b aligned vertically with the intermediate member 68 to be described later being interposed therebetween. The bars 64 are each set to be slightly shorter than vertical lengths of the first spring 63a and the second spring 63b in states of receiving no external force (in free length states). The pressing member 62 transfers pressing force generated by the air cylinder 61 to the upper surface 12S of the upper rim 12a to press the upper rim 12a downward.

The ring 67 in the lower structure is coupled to lower ends of the plurality of bars 64. The plurality of pressing pieces 70 extends downward from a lower surface of the ring 67. The lower structure in the body 62A according to the present embodiment has a plurality of pressing surfaces 62S respectively constituted by lower surfaces of the plurality of pressing pieces 70. Positions and the number of the plurality of pressing pieces 70 may not correspond to the positions and the number of the plurality of air cylinders 61.

The rim replacing mechanism 50 further includes the intermediate member 68 (exemplifying a support member according to the present invention) disposed between the connector members 65 and the lower structure. The intermediate member 68 has a constant relative position to the cylinder body 61A and a constant relative position to the upper spindle 9a. The intermediate member 68 and the cylinder body 61A are attached at positions not particularly limited as long as relative positions therebetween are fixed. The intermediate member 68 and the cylinder body 61A may be supported by the frame 52 via a bracket or the like (not depicted). The intermediate member 68 and the cylinder body 61A may alternatively be supported by a nonrotatable portion of the upper spindle 9a (e.g. a body of the upper spindle 9a). The intermediate member 68 (support member) may alternatively not be provided separately from the upper spindle 9a and constitute part of the upper spindle.

The connector members 65 each includes a flange 66. The flanges 66 are shaped to project horizontally (e.g. in an anteroposterior direction). Each of the flanges 66 has a lower surface connected to an upper end of a corresponding one of the bars 64. The bars 64 are each surrounded with the first spring 63a and the second spring 63b. The bars 64 each serve as a pressing bar achieving one of functions of the pressing member 62. The lower ends of the bars 64 are connected to an upper surface of the ring 67.

The springs specifically exemplified in FIG. 5 and constituting the elastic part 63 are compression springs. The plurality of first springs 63a is interposed between the ring 67 and the intermediate member 68. Each of the second springs 63b is interposed between the intermediate member 68 and a corresponding one of the connector members 65. Each of the first springs 63a and the second springs 63b has a vertically elongated shape and is configured to expand and contract vertically. The intermediate member 68 supports first ends (upper ends) of the plurality of first springs 63a, whereas the ring 67 supports second ends (lower ends) of the plurality of first springs 63a. Accordingly, each of the first springs 63a is restricted by the intermediate member 68 in terms of an upward shift and is restricted by the ring 67 in terms of a downward shift. Each of the first springs 63a contracts when the body 62A shifts upward relatively to the intermediate member 68, and expands when the body 62A shifts downward relatively to the intermediate member 68.

The intermediate member 68 supports first ends (lower ends) of the plurality of second springs 63b, whereas each of the connector members 65 supports a second end (upper end) of a corresponding one of the second springs 63b. Accordingly, each of the second springs 63b is restricted by the intermediate member 68 in terms of a downward shift and is restricted by the connector member 65 in terms of an upward shift. Each of the second springs 63b expands when the body 62A shifts upward relatively to the intermediate member 68, and contracts when the body 62A shifts downward relatively to the intermediate member 68.

The intermediate member 68 has a plurality of insertion holes vertically penetrating the intermediate member 68. The plurality of insertion holes receives the plurality of bars 64 inserted therethrough. The plurality of insertion holes in the intermediate member 68 is provided with sliding bushes 68a, respectively. Each of the sliding bushes 68a reduces resistance between the bar 64 and the intermediate member 68 and guides the bar 64.

Each of the sliding bushes 68a has a cylindrical shape and a through hole vertically penetrating the sliding bush 68a. The through hole in each of the sliding bush 68a slidably receives a corresponding one of the bars 64. The sliding bush 68a is interposed between an inner peripheral surface of each of the insertion holes in the intermediate member 68 and the bar 64 inserted through the insertion hole.

The intermediate member 68 supports the plurality of bars 64 via the plurality of sliding bushes 68a. Accordingly, each of the bars 64 is displaced only in one direction (only in the vertical direction) and is inhibited from being displaced in any direction other than the vertical direction, such as the transverse direction (horizontal direction). Each of the bars 64 is thus inhibited from having problems such as axial runout. Specifically, the sliding bush 68a limits movement of the bar 64 such that the bar 64 shifts only in the vertical direction. This configuration prevents the ring 67 from leaning and the pressing surfaces 62S constituted by the lower surfaces of the pressing pieces 70 from ununiformly pressing the upper surface 12S of the upper rim 12a.

In a case where the body 62A of the pressing member 62 is coupled to the cylinder rod 75 of each of the air cylinders 61, the sliding bush 68a allows the body 62A of the pressing member 62 to stably move in the vertical direction. Specifically, the intermediate member 68 and the plurality of sliding bushes 68a limit the direction of movement of the plurality of bars 64 to the vertical direction. The plurality of bars 64 constitutes part of the body 62A of the pressing member 62. The body 62A moving in the vertical direction is inhibited from moving in a direction slant from the vertical direction and from having a leaning posture. More specifically, in a case where the plurality of air cylinders 61 partly has a defect such as air clogging or dust biting and fails to operate normally, absence of the sliding bush 68a may cause the body 62A (specifically the ring 67 and the pressing pieces 70) to have a leaning posture. When the sliding bush 68a is provided in each of the insertion holes in the intermediate member 68, the body 62A coupled to the plurality of air cylinders 61 is inhibited from moving in a direction slanted from the vertical direction and from having a leaning posture.

The first spring 63a and the second spring 63b are disposed to vertically face each other with the intermediate member 68 being interposed therebetween and having the fixed relative position to each of the cylinder bodies 61A as described above, in order to achieve higher design flexibility of appropriately setting a stroke and spring force of the elastic part 63 in accordance with the weight of the body 62A. The reason for such disposition is specifically described below. If the first spring 63a and the second spring 63b are designed as an integrated spring and the elastic part 63 is constituted by ordinary commercial products, the elastic part 63 has difficulty in satisfying required conditions. There is thus need to prepare a custom-made spring, which lead to increase in cost. When the elastic part 63 is constituted by the first spring 63a and the second spring 63b disposed to vertically face each other with the intermediate member 68 being interposed therebetween as in the present embodiment, the elastic part 63 achieves higher design flexibility. This enables wider choices of the first spring 63a and the second spring 63b and accordingly achieves decrease in cost. The springs constituting the elastic part 63 have strokes and spring force that need to satisfy the following plurality of conditions that is difficult to be achieved with ordinary commercial products.

[Condition 1] In a standby state to be described later (where the air cylinders 61 are not pressurized with air), the lower surface 62S of the pressing member 62 is positioned below the lower surface 9S of the flange 55 in the upper spindle 9a.

[Condition 2] Spring force (elastic force of the entire elastic part 63) in the course of mounting the upper rim 12a to the upper spindle 9a varies from a time point (a) when the upper surface 12S of the upper rim 12a comes into contact with the lower surface 62S of the pressing member 62 to a time point (b) when the upper surface 12S of the upper rim 12a comes into contact with the lower surface 9S of the flange 55. Specifically, the spring force is applied upward to support the body 62A at the time point (a), is inverted to be applied downward at a time point between the time point (a) and the time point (b), and is applied downward at the time point (b).

[Condition 3] In a state immediately after the upper rim 12a is mounted to the upper spindle 9a (where the upper surface 12S of the upper rim 12a is in contact with the lower surface 9S of the flange 55 and the air cylinders 61 are not pressurized with air), the spring force is applied downward and has strength at a level of not separating the upper rim 12a from the upper spindle 9a.

In the state where the upper rim 12a is mounted to the upper spindle 9a, the downward pressing force (the spring force of the elastic part 63) applied from the first spring 63a to the body 62A is set to be less than a value obtained by subtracting the weight of the upper rim 12a from the magnetic force of the permanent magnets 56.

The pressing surfaces 62S positioned at a lower end of the pressing member 62, in other words, at lower ends of the pressing pieces 70, vertically face the upper surface 12S of the upper rim 12a. The pressing surfaces 62S apply pressing force to the upper surface 12S of the upper rim 12a fixed (held) to the upper spindle 9a. The pressing surfaces 62S press the upper surface 12S of the upper rim 12a at a radially outer position of the upper spindle 9a than positions where the permanent magnets 56 are attached to the flange 55. Specifically, the pressing surfaces 62S press the upper surface 12S at a position spaced apart radially outward from an outer circumferential surface of the flange 55.

The pressing surfaces 62S of the pressing member 62 are lower end surfaces of the pressing pieces 70 connected to the ring 67 surrounding the upper spindle 9a, the pressing pieces 70 extending downward. The ring 67 has a through hole 69 positioned at a center and loosely receiving the upper spindle 9a. The ring 67 is provided with the plurality of pressing pieces 70 (rim pressing members) extending downward from the lower surface of the ring 67. The present embodiment provides a pair of pressing pieces 70. The pressing pieces 70 each have an arc shape along an outer periphery of the upper spindle 9a in a planar view.

Described next is a rim replacing method with use of the rim replacing mechanism 50 according to the present embodiment.

FIG. 6 depicts a state of the rim replacing mechanism 50 when the tire test is conducted. The switching valve 78 is switched into the first allowance state in this case. The first allowance state allows compressed air from the compressor to be supplied into the lower chamber 73D communicating with the lower port 77, and allows air to be exhausted from the upper chamber 73U through the upper port 76. Specifically, the air compressed by the compressor is supplied only into the lower chamber 73D in the cylinder chamber 73 partitioned by the piston 74, and the piston 74 shifts upward. The piston 74 and the cylinder rod 75 of each of the air cylinders 61 are thus shifted upward, and the body 62A (the pressing pieces 70, the ring 67, the bars 64, and the connector members 65) of the pressing member 62 is also shifted upward. The body 62A of the pressing member 62 is located at the upper position, the lower end surfaces of the pressing pieces 70, in other words, the pressing surfaces 62S of the pressing member 62 are positioned above the lower surface 9S of the upper spindle 9a and above lower surfaces of the permanent magnets 56 and are disposed above and spaced apart from the upper surface 12S of the upper rim 12a.

In the state depicted in FIG. 6, the upper rim 12a is mounted to the upper spindle 9a and is fixed to the upper spindle 9a with magnetic force of the permanent magnets 56. Furthermore, the lower rim 12b is mounted to the lower spindle 9b and is fixed to the lower spindle 9b with the magnetic force of the permanent magnets. The upper and lower rims 12a and 12b are vertically spaced apart from each other in the state depicted in FIG. 6.

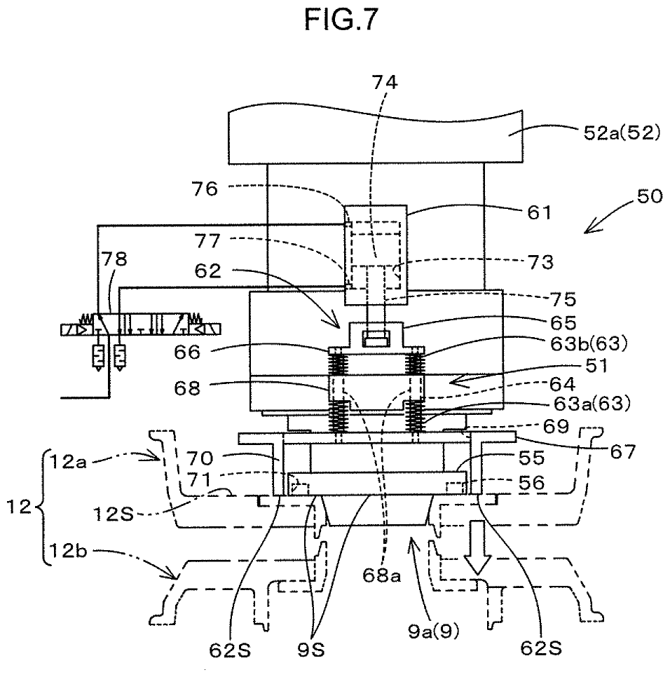

FIG. 7 depicts a state of detaching the upper rim 12a from the upper spindle 9a. In order to switch from the state depicted in FIG. 6 (the state where the tire test is being conducted) to the detaching state depicted in FIG. 7, the switching valve control section 81 in the controller 80 controls operation of the switching valve 78 such that the switching valve 78 is switched from the first allowance state into the second allowance state.

Specifically, the second allowance state allows compressed air from the compressor to be supplied into the upper chamber 73U communicating with the upper port 76, and allows air to be exhausted from the lower chamber 73D communicating with the lower port 77. The air compressed by the compressor is supplied only to the upper chamber 73U in the cylinder chamber 73 partitioned by the piston 74, and the piston 74 and the cylinder rod 75 shift downward. In this case, downward pressing force of the air cylinders 61 is more than the value obtained by subtracting the weight of the upper rim 12a from the force, of the permanent magnets 56, attracting the upper rim 12a to the upper spindle 9a. The downward pressing force is transferred to the upper surface 12S of the upper rim 12a through the connector members 65, the bars 64, the ring 67, and the pressing pieces 70. The upper rim 12a is powerfully pressed downward with the pressing force. The body 62A of the pressing member 62 is thus shifted further downward from the position indicated in FIG. 7 to reach the lower position.

As to the lower position, the body 62A is configured to shift downward toward the lower position while the pressing surfaces 62S of the body 62A are applying the downward pressing force to the upper surface 12S of the upper rim 12a, to dispose the upper surface 12S of the upper rim 12a to be separated downward from the lower surface 9S of the upper spindle 9a. When the body 62A reaches the lower position, the upper surface 12S of the upper rim 12a is accordingly positioned below and spaced apart from the lower surface 9S of the upper spindle 9a.

In a case that the lower position does not match the body lower limit position corresponding to the lower stroke end of the actuator, the compressed air generates downward pressing force to shift the piston 74 and the cylinder rod 75 further downward and the body 62A reaches the body lower limit position. The upper rim 12a is thus separated from the upper spindle 9a reliably and quickly.

The upper rim 12a thus separated from the upper spindle 9a is disposed on the lower rim 12b and descends along with the lower spindle 9b. The upper rim 12a is accordingly detached from the upper spindle 9a. When the lower spindle 9b further descends and the lower rim 12b reaches the upper surface of the rim table 13, the lower rim 12b is detached from the lower spindle 9b and the lower rim 12b and the upper rim 12a stacked thereon are disposed on the upper surface of the rim table 13.

FIG. 5 depicts a state of mounting the upper rim 12a to the upper spindle 9a. In a state where the upper rim 12a is detached from the upper spindle 9a and the body 62A of the pressing member 62 is located at the standby position indicated in FIG. 5, executed is control to mount the upper rim 12a to the upper spindle 9a. When the upper rim 12a is mounted to the upper spindle 9a, the switching valve control section 81 in the controller 80 controls the switching valve 78 into the inhibition state in the state where the upper rim 12a is detached from the upper spindle 9a. The body 62A is thus disposed at the standby position.

As depicted in FIG. 5, the switching valve 78 switched into the inhibition state opens both the upper and lower ports 76 and 77.

When the switching valve 78 is in the state depicted in FIG. 5, compressed air is supplied to neither the upper chamber 73U nor the lower chamber 73D with substantially no difference in air pressure between the upper chamber 73U and the lower chamber 73D. Furthermore, air is allowed to be exhausted from the upper chamber 73U and the lower chamber 73D, so that the piston 74 is shiftable upward and downward in the cylinder chamber 73. When the body 62A is disposed at the standby position indicated in FIG. 5, the downward pressing force (elastic force) of the first spring 63a is preferred, but not essentially, to be applied to the body 62A of the pressing member 62. Assume the case where the standby position is located below the lower position as described above. The downward pressing force of the first spring 63a may not necessarily be applied to the body 62A when the body 62A is disposed at the standby position. The downward pressing force of the first spring 63a has only to be applied to the body 62A when the body 62A is disposed at the lower position above the standby position. The pressing force (elastic force) of the first spring 63a can mitigate impact caused upon newly mounting the upper rim 12a to the upper spindle 9a.

As described above, the rim replacing mechanism 50 depicted in FIG. 5 is in the standby state of standing by for mounting the upper rim 12a to the upper spindle 9a. In the standby state, the body 62A is disposed at the standby position and the lower end surfaces of the pressing pieces 70 (i.e. the lower surfaces 62S of the body 62A of the pressing member 62) project downward than the lower surface 9S of the flange 55. The elastic part 63 has a spring constant set such that the lower surface 62S of the body 62A is positioned below the lower surface 9S of the upper spindle 9a in the standby state.

Specifically, the springs 63a and 63b each have a spring constant and a length set in consideration of the conditions 1 to 3 or the like.

As described above, the elastic part 63 according to the present embodiment includes the first spring 63a disposed below the intermediate member 68 and the second spring 63b disposed above the intermediate member 68. The plurality of springs 63a and 63b is disposed to vertically face each other with the intermediate member 68 being interposed therebetween, so that the elastic part 63 applies spring force in the two direction, specifically, upward and downward. The spring force of the elastic part 63 can be varied by adjusting the lengths of the springs to secure design flexibility.

In the rim replacing mechanism 50 in the standby state (as depicted in FIG. 5), when the lower spindle 9b having the upper end mounting the upper rim 12a and the lower rim 12b ascends and the upper rim 12a approaches the permanent magnets 56 to have the upper surface 12S of the upper rim 12a included in a range influenced by the magnetic force of the permanent magnets 56, the magnetic force of the permanent magnets 56 is applied to the upper rim 12a and the upper rim 12a is shifted upward toward the upper spindle 9a.

In the standby state, the lower end surfaces 62S of the pressing pieces 70, i.e., the lower surfaces 62S of the body 62A of the pressing member 62 are positioned below the lower surface 9S of the flange 55. The upper surface 12S of the upper rim 12a attracted to the upper spindle 9a with magnetic force thus comes into contact with the lower surfaces 62S of the body 62A of the pressing member 62 before contacting the lower surface 9S of the flange 55. The body 62A located at the standby position upon the contact ascends as the upper rim 12a is raised to approach the lower surface 9S of the upper spindle 9a with the magnetic force. The first spring 63a has downward pressing force applied to the body 62A in this case. Contact of the upper surface 12S of the upper rim 12a to the lower surface 9S of the upper spindle 9a causes impact mitigated by the contracting first spring 63a. This configuration inhibits damage to the upper surface 12S and the lower surface 9S as magnetically attracted surfaces (close contact surfaces), large impact noise, and the like. In at least part of a time period from contact of the upper surface 12S of the upper rim 12a to the lower surface 62S of the body 62A to contact to the lower surface 9S of the flange 55 in the upper spindle 9a, the upper rim 12a receives the downward pressing force of the first spring 63a to mitigate impact caused upon mounting of the upper rim 12a to the upper spindle 9a.

When the upper rim 12a is fixed to the upper spindle 9a in this manner, the rim replacing mechanism 50 is switched again into the state depicted in FIG. 6. In this state, the piston 74 shifts upward and the pressing pieces 70 are disposed above and spaced apart from the upper surface 12S of the upper rim 12a. In the state depicted in FIG. 6, the tire test can be conducted. The upper rim 12a in the state depicted in FIG. 6 is detached with use of the rim replacing mechanism 50 in accordance with the procedure described above.

In the rim replacing mechanism 50 according to the present embodiment, the air cylinder 61 and the bracket supporting the air cylinder 61 are fixed to the upper frame 52a so as not to rotate integrally with the upper spindle 9a. In other words, the rim replacing mechanism 50 has a structure nonrotatable along with rotation of the upper spindle 9a. This configuration inhibits, in the tire test, addition of any error component due to rotation of the rim replacing mechanism 50 to a uniformity measurement system. Uniformity can thus be measured accurately.

The rim replacing mechanism 50 (the rim separating mechanism 51) according to the present embodiment can inhibit various affects upon mounting of the upper rim 12a to the upper spindle 9a.

Specifically, in the rim replacing mechanism 50, the length of the bars 64, the lengths of the springs 63a and 63b, and the position of the intermediate member 68 are adjusted such that the body 62A of the pressing member 62 receives downward pressing force. Accordingly, the elastic part 63 mitigates impact force upon mounting of the upper rim 12a to the upper spindle 9a, to reduce damage to the upper surface 12S of the upper rim 12a and the lower surface 9S of the upper spindle 9a and impact noise.

In the standby state. there is formed an air circuit with both the ports 76 and 77 of the air cylinder 61 being opened. In other words, the cylinder rod 75 of the air cylinder 61 can expand and contract freely in the standby state. When the first sensor detects that the upper rim 12a is mounted to the upper spindle 9a in the standby state, the controller 80 receiving a relevant signal controls operation of the switching valve 78 such that the piston 74 of the air cylinder 61 ascends. When the second sensor detects that the piston 74 of the air cylinder 61 reaches the upper limit position, the controller 80 receiving a relevant signal controls operation of the lift cylinder 72 such that the lower spindle 9b descends. The upper rim 12a and the lower rim 12b are thus quickly fixed to the upper spindle 9a and the lower spindle 9b, respectively.

The pressing surfaces 62S of the pressing member 62 pressing the upper surface 12S of the upper rim 12a subjected to the tire test are positioned to press even if the upper rim 12a has any size within a range from a minimum diameter to a maximum diameter of the upper rim 12a. As depicted in FIG. 6, the lower surface of the ring 67 is provided with the pressing pieces 70 (members pressing the rim 12) extending downward from the lower surface. Even if the pressing surfaces 62S press the upper surface 12S of the upper rim 12a at positions limited within a radially small range, the pressing surfaces 62S can thus appropriately press the upper surface 12S of the upper rim 12a. Furthermore, even if the air cylinder 61 is limited in terms of its attached position, the pressing surface 62S can appropriately press the upper surface 12S of the upper rim 12a.

As depicted in FIG. 6, the elastic part 63 includes the second spring 63b disposed above and the first spring 63a disposed below with the intermediate member 68 being interposed therebetween. This configuration achieves higher flexibility of adjusting the spring constants of the springs 63a and 63b pressing the body 62A of the pressing member 62. As depicted in FIG. 6, the connector member 65 is provided with play allowing the lower end of the cylinder rod 75 to be shiftable in the vertical direction relatively to the connector member 65. This play is provided to cause a shift amount of the pressing member 62 to be less (shorter) than a stroke of the cylinder rod 75 of the air cylinder 61.

As described above, the rim mounting surface of the rim table 13 is provided thereon with the plurality of rims 12 different in size. The present embodiment achieves mounting, to the upper spindle 9a, any one of the upper rims 12a different in size and weight. In the state where the upper rim 12a is mounted to the upper spindle 9a, the downward pressing force applied from the first spring 63a to the body 62A is set to be less than a value obtained by subtracting, from the magnetic force of the permanent magnets 56, weight of a heaviest one of the plurality of upper rims 12a mountable to the upper spindle 9a.

As describe above, the rim replacing mechanism 50 included in the tire testing machine 1 according to the present embodiment includes the rim separating mechanism 51. The rim separating mechanism 51 includes the pressing member 62 provided with the elastic part 63, to inhibit various affects upon mounting of the upper rim 12a to the upper spindle 9a.

In order to solve the problems relevant to impact caused upon contact of the upper rim to the upper spindle, the tire testing machine may adopt a hydraulic cylinder (hydraulic jack) functioning as the rim separating mechanism to mitigate the impact with use of the hydraulic cylinder. Specifically, the tire testing machine thus configured to solve the problems includes the rim separating mechanism configured to detach the upper rim from the upper spindle. The rim separating mechanism includes the hydraulic cylinder provided to be vertically hung from the upper frame and configured to generate downward pressing force, and a pressing member having a lower end pressing the upper rim with the pressing force of the hydraulic cylinder. In the tire testing machine thus configured, the hydraulic cylinder in the rim separating mechanism is used also as a device configured to mitigate impact caused upon magnetic attraction of the upper rim.

Specifically, the upper rim is detached for replacement, the hydraulic cylinder is expanded downward until another upper rim is mounted to the upper spindle, and the pressing member is pressed downward (rim pressing operation), When the upper rim is magnetically attracted to the upper spindle in this state, the hydraulic cylinder is pressed back due to a difference between the downward pressing force of the hydraulic cylinder and ascending force of the lower spindle to exhibit cushioning effect that mitigates impact force upon mounting of the upper rim. After the upper rim is mounted to the upper spindle, a sensor detects that the upper rim is reliably mounted, the hydraulic jack is depressurized, and the lower spindle descends to complete rim replacement.

The operation described above can avoid the problems upon mounting of the upper rim (e.g. generation of impact noise). This measure may have the following problems. For example, the operation of the hydraulic cylinder (operation for avoiding the problems upon magnetic attraction of the upper rim) is included in a series of operation for rim automatic change. The rim replacement may, however, be achieved manually in some cases. In this case, manual operation of individually executing the rim pressing operation and operation of raising the lower spindle may include operation of raising the lower spindle mounting the upper and lower rims while the rim pressing operation is not executed. This fails to achieve mitigation of impact caused upon mounting of the upper rim to the upper spindle.

There may be provided a sensor configured to detect whether or not the upper rim is mounted to the upper spindle. In a case where the sensor does not detect the upper rim, the upper rim is not removed from the upper spindle. However, if the sensor configured to detect the upper rim operates erroneously for some reason and the upper rim is determined as not being mounted although the upper rim is mounted to the upper spindle, the hydraulic cylinder may press the upper rim downward to drop the rim. If the hydraulic cylinder is adopted to achieve two functions of separating the upper rim and mitigating impact caused upon mounting of the upper rim, the above various problems caused by such multiple operation will not be solved completely. The measure includes depressurizing the hydraulic cylinder after the sensor detects reliable close contact of the upper rim to the upper spindle, and a timer counts time until the hydraulic cylinder is sufficiently depressurized. Such a measure takes long time to achieve the depressurization, and takes long time until the lower spindle descends to a predetermined position and the operation is completed,

The embodiment disclosed herein should be regarded as being exemplary and nonlimitive at any point. The present invention can include the following aspects.

(A) As depicted in FIG. 5 and the like, the first spring 63a and the second spring 63b are disposed with the intermediate member 68 being interposed therebetween in the above embodiment. However, the present invention is not limited to this embodiment. For example, the elastic part 63 depicted in FIG. 5 may include the first spring 63a and not include the second spring 63b. If the body 62A is disposed at the body lower limit position in this case, the body 62A may be supported by the lower end of the cylinder rod 75 of the air cylinder 61, or the body 62A may be supported in a state where a lower surface of the connector member 65 is in contact with an upper surface of the intermediate member 68.

(B) As depicted in FIG. 5 and the like, the rim replacing mechanism 50 according to the above embodiment includes the support member (the intermediate member 68). However, the present invention is not limited to this embodiment. In FIG. 5, the support member (the intermediate member 68) may not be provided and the elastic part 63 may be constituted by at least one first spring 63a. In this case, the lower end of each of the bars 64 may be fixed to the ring 67 in the lower structure and an upper end of the bar 64 may be inserted through a through hole provided in the upper member (the connector member 65). In this configuration, the bar 64 is shiftable in the vertical direction relatively to the connector member 65 when the body 62A shifts in the vertical direction.

(C) When the upper rim 12a approaches the permanent magnets 56 to be positioned within the range influenced by the magnetic force of the permanent magnets 56 in the above embodiment, the upper rim 12a is attracted to the upper spindle 9a with the magnetic force, and the upper surface 12S of the upper rim 12a then comes into contact with the lower surface 62S of the body 62A of the pressing member 62 before contacting the lower surface 9S of the flange 55. The present invention is not limited to this embodiment. For example, the upper rim 12a may further ascend after the upper surface 12S of the upper rim 12a comes into contact with the lower surface 62S of the body 62A of the pressing member 62 to be attracted to the upper spindle 9a with the magnetic force.

Particularly, the embodiment disclosed herein includes matters not disclosed explicitly, such as running conditions, operation conditions, various parameters, as well as dimensions, weight, volume, and the like of constituent elements. These matters have values set so as not to depart from an ordinarily implemented range by those skilled in the art and so as to be easily assumed by those skilled in the art.

As described earlier, it is an object of the present invention to provide a rim replacing mechanism included in a tire testing machine and a rim replacing method, which achieve mitigation of impact caused when an upper rim to be mounted to an upper spindle comes into contact with the upper spindle.

Provided is a rim replacing mechanism for a tire testing machine. The rim replacing mechanism is included in the tire testing machine. The tire testing machine includes a plurality of rims each configured to hold a tire, the rims each including an upper rim and a lower rim, an upper spindle detachably provided with the upper rim included in any one selected from the plurality of rims, the upper spindle having a lower surface in contact with an upper surface of the upper rim mounted to the upper spindle and a permanent magnet fixing to the upper spindle with magnetic force, the upper rim mounted to the upper spindle, and a lower spindle provided with the lower rim. The rim replacing mechanism is configured to replace the upper rim fixed to the upper spindle. The rim replacing mechanism includes: a pressing member including a body and a spring, the body having a pressing surface applying downward pressing force to the upper surface of the upper rim; and an actuator configured to vertically displace the body within a range including an upper position and a lower position. The pressing surface of the body disposed at the upper position is located above the upper surface of the upper rim mounted to the upper spindle. The lower position is located below the upper position, and the body is configured to shift downward toward the lower position while the pressing surface of the body is applying the downward pressing force to the upper surface of the upper rim, to dispose the upper surface of the upper rim to be separated downward from the lower surface of the upper spindle. The spring is configured to apply downward pressing force to the body disposed at the lower position.

In the rim replacing mechanism included in the tire testing machine, the actuator disposes the body of the pressing member at the upper position when the tire test is conducted along with rotation of the upper and lower rims and rotation of the upper and lower spindles. When the body is disposed at the upper position, the pressing surface of the body is positioned above the upper surface of the upper rim mounted to the upper spindle. Accordingly, the body of the pressing member does not disturb rotation of the upper rim and the upper spindle. When the upper rim fixed to the upper spindle is detached from the upper spindle to be replaced with another upper rim, the actuator shifts the body of the pressing member downward to the lower position or a potion below the lower position (e.g. the standby position). In this configuration, the body shifts to the lower position while the pressing surface of the body is applying the downward pressing force to the upper surface of the upper rim, to dispose the upper surface of the upper rim to be separated downward from the lower surface of the upper spindle. When the other upper rim is mounted to the upper spindle, the other upper rim positioned below the upper spindle is made to approach the upper spindle in a state where the body is disposed at the standby position. The upper rim, which has approached to be sufficiently influenced by the magnetic force of the permanent magnet in the upper spindle, is attracted with the magnetic force to shift toward the upper spindle. If the body is disposed at the standby state while the upper rim is being shifted, the upper surface of the upper rim comes into contact with the pressing surface of the body before contacting the lower surface of the upper spindle. In the rim replacing mechanism, the spring is configured to apply downward pressing force to the body disposed at the lower position. The downward pressing force of the spring reduces upward shift speed of the body and the upper rim. This allows impact caused upon contact of the upper surface of the upper rim to the lower surface of the upper spindle to be mitigated by the downward pressing force of the spring.

In the rim replacing mechanism included in the tire testing machine, preferably, the upper spindle is rotatably supported by a frame of the tire testing machine, and the actuator is fixed to the frame. In a case where the actuator is fixed to the upper spindle so as to rotate along with the upper spindle, the tire test has a measurement result including any error component due to rotation of the actuator, to cause deterioration in accuracy of the tire test. The actuator according to the present aspect is fixed not to the upper spindle but to the frame, so as not to rotate even when the upper spindle rotates. This configuration inhibits addition of the error component due to rotation of the actuator to the measurement result of the tire test. The tire test is thus inhibited from deterioration in accuracy.

In the rim replacing mechanism included in the tire testing machine, preferably, the spring is configured to vertically expand and contract, and the body of the pressing member includes a bar vertically penetrating the spring and supporting the spring. According to this aspect, the spring configured to expand and contract in the vertical direction is supported by the bar vertically penetrating the spring. This configuration inhibits deformation of the spring in any direction other than the vertical direction. The spring is thus inhibited from having variation in downward pressing force applied to the body.

In the rim replacing mechanism included in the tire testing machine, optionally, the actuator is an air cylinder including a cylinder body defining a cylinder chamber and a piston accommodated in the cylinder chamber and partitioning the cylinder chamber into an upper chamber and a lower chamber, the piston being configured to vertically ascend and descend in the cylinder chamber, and the body is configured to be vertically displaced along with vertical ascending and descending of the piston. According to this aspect, the air cylinder enables vertical displacement of the body.

Optionally, the rim replacing mechanism included in the tire testing machine further includes a support member having a constant relative position to the cylinder body and supporting a first end of the spring; in which the body of the pressing member supports a second end of the spring, and the spring is configured to vertically expand and contract along with change of a vertical relative position of the body to the support member. According to this aspect, the first end of the spring is supported by the support member having the unchanged relative position to the cylinder body, and the second end of the spring is supported by the body having the relative position to the cylinder body changed in accordance with vertical displacement of the piston. The spring thus vertically expands or contracts in accordance with change of the relative position in the vertical direction of the body to the support member. This allows impact caused upon contact of the upper surface of the upper rim to the lower surface of the upper spindle to be mitigated in the simple configuration including the support member.

The rim replacing mechanism included in the tire testing machine further includes a support member having a constant relative position to the cylinder body and supporting a first end of the spring; in which the body of the pressing member includes an upper member configured to be vertically shiftable along with ascending or descending of the piston, a lower member positioned below the upper member, and a bar extending downward from the upper member to the lower member to couple the upper member and the lower member, the support member is interposed between the upper member and the lower member, the support member has an insertion hole vertically penetrating the support member and through which the bar is inserted, the rim replacing mechanism further includes a sliding bush disposed at the insertion hole in the support member, the sliding bush has a through hole vertically penetrating the sliding bush and allowing the bar to be slidably inserted therethrough, and the bar is configured to be vertically shiftable along with the upper member while being supported by the sliding bush. According to this aspect, the support member supports the bar via the sliding bush. The bar being displaced in the vertical direction is thus inhibited from being displaced in a direction other than the vertical direction, such as the horizontal direction. The bar is thus inhibited from having problems such as axial runout.

Preferably, the rim replacing mechanism included in the tire testing machine further includes: a switching valve configured to be switched among a first allowance state of allowing compressed air to be supplied into the lower chamber in the cylinder chamber and allowing air to be exhausted from the upper chamber in the cylinder chamber, a second allowance state of allowing the compressed air to be supplied into the upper chamber and allowing air to be exhausted from the lower chamber, and an inhibition state of allowing air to be exhausted from the upper chamber and the lower chamber and inhibiting supply of the compressed air into the upper chamber and the lower chamber; and a switching valve control section configured to control operation of the switching valve; in which the switching valve control section controls to switch the switching valve into the first allowance state such that the body of the pressing member is disposed at the upper position when the tire test is conducted, controls to switch the switching valve into the second allowance state such that the body of the pressing member is disposed at the lower position when the upper rim is detached from the upper spindle, and controls to switch the switching valve into the inhibition state in a state where the upper rim is detached from the upper spindle when the upper rim is mounted to the upper spindle. According to this aspect, the switching valve control section in the controller automatically and reliably operates the pressing member as needed upon conduction of the tire test, detachment of the upper rim, and mounting of the upper rim.

In the rim replacing mechanism included in the tire testing machine, preferably, in a state where the upper rim is mounted to the upper spindle, the downward pressing force applied from the spring to the body is set to be less than a value obtained by subtracting, from magnetic force of the permanent magnet, weight of a heaviest one of a plurality of upper rims in the plurality of rims. The tire test is conducted in the state where the upper rim is mounted to the upper spindle. When the downward pressing force of the spring to be applied to the body in such a mounting state is less than the value obtained by subtracting the weight from the magnetic force, the upper rim can be held by the upper spindle.

Optionally, the rim replacing mechanism included in the tire testing machine further includes a support member having a constant relative position to the upper spindle, in which the body of the pressing member includes a lower member positioned below the support member, the spring of the pressing member is interposed between the support member and the lower member, the spring has an upper end supported by the support member and a lower end supported by the lower member, the spring is configured to contract to allow the lower member to approach the support member, and apply downward pressing force to the lower member of the body with elastic force of the spring when the body is positioned at least between the upper position and the lower position. This aspect allows impact caused upon contact of the upper surface of the upper rim to the lower surface of the upper spindle to be mitigated in the simple configuration including the support member.

Optionally, in the rim replacing mechanism included in the tire testing machine, the body of the pressing member includes an upper member positioned above the support member, and a bar extending downward from the upper member to the lower member to couple the upper member and the lower member, the spring of the pressing member corresponds to a first spring interposed between the support member and the lower member and having an upper end supported by the support member and a lower end supported by the lower member, the pressing member further includes a second spring interposed between the support member and the upper member and having an upper end supported by the upper member and a lower end supported by the support member, the first spring is configured to contract to allow the lower member to approach the support member and apply downward pressing force to the lower member of the body with elastic force of the first spring being contracted, and the second spring is configured to contract to allow the upper member to approach the support member and apply upward pressing force to the upper member of the body with elastic force of the second spring being contracted. According to this aspect, the first spring is disposed below the support member and the second spring is disposed above the support member, to achieve higher design flexibility of the elastic part including the first spring and the second spring as described earlier.

There is provided a rim replacing method executed with use of the rim replacing mechanism included in the tire testing machine, the method including, when the body is disposed at the lower position or below the lower position, causing the upper rim positioned below the upper spindle to approach the upper spindle, and causing the upper surface of the upper rim to come into contact with the pressing surface of the body before contacting the lower surface of the upper spindle. This method allows impact caused upon contact of the upper surface of the upper rim to the lower surface of the body to be mitigated by the downward pressing force of the spring.

1. A rim replacing mechanism included in a tire testing machine including a plurality of rims each configured to hold a tire, the rims each including an upper rim and a lower rim, an upper spindle detachably provided with the upper rim included in any one selected from the plurality of rims, the upper spindle having a lower surface in contact with an upper surface of the upper rim mounted to the upper spindle and a permanent magnet fixing to the upper spindle with magnetic force, the upper rim mounted to the upper spindle, and a lower spindle provided with the lower rim, the rim replacing mechanism configured to replace the upper rim fixed to the upper spindle and comprising:
a pressing member including a body and a spring, the body having a pressing surface applying downward pressing force to the upper surface of the upper rim; and
an actuator configured to vertically displace the body within a range including an upper position and a lower position, wherein
the pressing surface of the body disposed at the upper position is located above the upper surface of the upper rim mounted to the upper spindle,
the lower position is located below the upper position, the body is configured to shift downward toward the lower position while the pressing surface of the body being applying the downward pressing force to the upper surface of the upper rim, to dispose the upper surface of the upper rim to be separated downward from the lower surface of the upper spindle, and
the spring is configured to apply downward pressing force to the body disposed at the lower position.

2. The rim replacing mechanism included in the tire testing machine according to claim 1, wherein
the upper spindle is rotatably supported by a frame of the tire testing machine, and
the actuator is fixed to the frame.

3. The rim replacing mechanism included in the tire testing machine according to claim 1, wherein
the spring is configured to vertically expand and contract, and
the body of the pressing member includes a bar vertically penetrating the spring and supporting the spring.

4. The rim replacing mechanism included in the tire testing machine according to claim 1, wherein
the actuator is an air cylinder including a cylinder body defining a cylinder chamber and a piston accommodated in the cylinder chamber and partitioning the cylinder chamber into an upper chamber and a lower chamber, the piston being configured to vertically ascend and descend in the cylinder chamber, and
the body is configured to be vertically displaced along with vertical ascending and descending of the piston.

5. The rim replacing mechanism included in the tire testing machine according to claim 4, further comprising a support member having a constant relative position to the cylinder body and supporting a first end of the spring, wherein
the body of the pressing member supports a second end of the spring, and
the spring is configured to vertically expand and contract along with change of a vertical relative position of the body to the support member.

6. The rim replacing mechanism included in the tire testing machine according to claim 4, further comprising a support member having a constant relative position to the cylinder body and supporting a first end of the spring, wherein
the body of the pressing member includes an upper member configured to be vertically shiftable along with ascending or descending of the piston, a lower member positioned below the upper member, and a bar extending downward from the upper member to the lower member to couple the upper member and the lower member,
the support member is interposed between the upper member and the lower member,
the support member has an insertion hole vertically penetrating the support member and through which the bar is inserted,
the rim replacing mechanism further comprises a sliding bush disposed at the insertion hole in the support member,
the sliding bush has a through hole vertically penetrating the sliding bush and allowing the bar to be slidably inserted therethrough, and
the bar is configured to be vertically shiftable along with the upper member while being supported by the sliding bush.

7. The rim replacing mechanism included in the tire testing machine according to claim 4, further comprising:
a switching valve configured to be switched among a first allowance state of allowing compressed air to be supplied into the lower chamber in the cylinder chamber and allowing air to be exhausted from the upper chamber in the cylinder chamber, a second allowance state of allowing the compressed air to be supplied into the upper chamber and allowing air to be exhausted from the lower chamber, and an inhibition state of allowing air to be exhausted from the upper chamber and the lower chamber and inhibiting supply of the compressed air into the upper chamber and the lower chamber; and
a switching valve control section configured to control operation of the switching valve, wherein
the switching valve control section
controls to switch the switching valve into the first allowance state such that the body of the pressing member is disposed at the upper position when the tire test is conducted,
controls to switch the switching valve into the second allowance state such that the body of the pressing member is disposed at the lower position when the upper rim is detached from the upper spindle, and
controls to switch the switching valve into the inhibition state in a state where the upper rim is detached from the upper spindle when the upper rim is mounted to the upper spindle.

8. The rim replacing mechanism included in the tire testing machine according to claim 1, wherein
in a state where the upper rim is mounted to the upper spindle, the downward pressing force applied from the spring to the body is set to be less than a value obtained by subtracting, from magnetic force of the permanent magnet, weight of a heaviest one of a plurality of upper rims in the plurality of rims.

9. The rim replacing mechanism included in the tire testing machine according to claim 1, further comprising
a support member having a constant relative position to the upper spindle, wherein
the body of the pressing member includes a lower member positioned below the support member,
the spring of the pressing member is interposed between the support member and the lower member, the spring has an upper end supported by the support member and a lower end supported by the lower member, and
the spring is configured to contract to allow the lower member to approach the support member, and apply downward pressing force to the lower member of the body with elastic force of the spring when the body is positioned at least between the upper position and the lower position.

10. The rim replacing mechanism included in the tire testing machine according to claim 9, wherein
the body of the pressing member includes an upper member positioned above the support member, and a bar extending downward from the upper member to the lower member to couple the upper member and the lower member,
the spring of the pressing member corresponds to a first spring interposed between the support member and the lower member and having an upper end supported by the support member and a lower end supported by the lower member,
the pressing member further includes a second spring interposed between the support member and the upper member and having an upper end supported by the upper member and a lower end supported by the support member,
the first spring is configured to contract to allow the lower member to approach the support member and apply downward pressing force to the lower member of the body with elastic force of the first spring being contracted, and
the second spring is configured to contract to allow the upper member to approach the support member and apply upward pressing force to the upper member of the body with elastic force of the second spring being contracted.

11. A rim replacing method executed with use of the rim replacing mechanism included in the tire testing machine according to claim 1, the method comprising
when the body is disposed at the lower position or below the lower position, causing the upper rim positioned below the upper spindle to approach the upper spindle, and causing the upper surface of the upper rim to come into contact with the pressing surface of the body before contacting the lower surface of the upper spindle.
